(19) United States
(12) Patent Application Publication
(10) Pub. No.: US 2019/0043325 A1
(43) Pub. Date: Feb. 7, 2019

(54) DOORBELL DEVICE

(71) Applicant: LG INNOTEK CO., LTD., Seoul (KR)

(72) Inventor: Ki Kyung JEON, Seoul (KR)

(73) Assignee: LG Innotek Co., Ltd., Seoul (KR)

(21) Appl. No.: 15/759,691

(22) PCT Filed: Sep. 8, 2016
(86) PCT No.: PCT/KR2016/010057

§ 371 Date: Mar. 13, 2018

(30) Foreign Application Priority Data
Sep. 15, 2015 (KR) 10-2015-0130276

(51) Int. Cl. G08B 13/196; G08B 3/10

(52) U.S. Cl. CPC G08B 13/1963; G08B 13/19619; G08B 13/19632; G08B 3/10

(57) ABSTRACT

A doorbell device including: a bracket including a fixed surface coupled to a support structure; a viewing angle-adjusting bracket rotatably coupled to the bracket and including a front surface inclined with respect to the fixed surface; and a doorbell body coupled to the viewing angle-adjusting bracket and including a camera having an optical axis inclined with respect to an axis center of the viewing angle-adjusting bracket. A viewing angle of the camera can be arbitrarily changed by a user so that a visitor's identifiability can be improved.

### TECHNICAL FIELD

The present invention relates to a doorbell device.

### BACKGROUND ART

A doorbell device is a device with which a visitor informs somebody indoors of his/her visit using voice or video. A camera may be installed in the doorbell device to make it possible to check the surrounding environment of an entrance door from indoors using the video when the visitor rings a bell.

In general, in a doorbell device, a body including the bell in addition to the camera is coupled to a wall surface near the door using a bracket. In this case, because the camera is fixed to the body when installed, a viewing angle of the camera is fixed. Thus, according to an installation environment of the doorbell device, there is a blind spot of which video information cannot be acquired using the camera. When the visitor is in the blind spot, it is difficult to identify the visitor.

### DISCLOSURE

### Technical Problem

The present invention is directed to providing a doorbell device capable of changing a viewing angle of a camera.

The problem to be solved is not limited to the above-described problem, and other unmentioned problems will be clearly understood by those skilled in the art from the following description.

### Technical Solution

One aspect of the present invention provides a doorbell device including: a bracket including a fixed surface coupled to a support structure; a viewing angle-adjusting bracket rotatably coupled to the bracket and including a front surface inclined with respect to the fixed surface; and a doorbell body coupled to the viewing angle-adjusting bracket and including a camera having an optical axis inclined with respect to an axis center of the viewing angle-adjusting bracket.

The bracket and the viewing angle-adjusting bracket may be disposed to rotate about a concentric axis.

A length of a top surface of the viewing angle-adjusting bracket and a length of a bottom surface thereof may be different from each other.

Another aspect of the present invention provides a doorbell device including: a bracket including a fixed surface coupled to a support structure; a viewing angle-adjusting bracket coupled to the bracket and including a front surface inclined with respect to the fixed surface; and a doorbell body including a body coupled to the bracket and a rotation block, the rotation block including a camera which is rotatably coupled to the body and including an inclined contact surface in contact with the front surface.

The camera may be installed on the rotation block so that an optical axis of the camera is inclined with respect to an axis center of the rotation block.

The bracket may include a driving unit connected to the rotation block and configured to rotate the rotation block.

The driving unit may include a motor, and an axis center of the motor may be perpendicular to the front surface.

The doorbell device may further include a controller configured to control the driving unit.

### Advantageous Effects

According to an embodiment, a viewing angle-adjusting bracket is rotatably coupled to a bracket, and a fixed surface on which a doorbell body is mounted is obliquely disposed so that a viewing angle of a camera can be arbitrarily changed by a user and thus a visitor's identifiability can be improved.

According to an embodiment, a doorbell device includes a viewing angle-adjusting bracket including an obliquely disposed front surface and a doorbell body that is in contact with the front surface so as to be rotatable and includes a rotation block having a camera so that the viewing angle of the camera can be arbitrarily changed by a user and thus a visitor's identifiability can be improved.

### DESCRIPTION OF DRAWINGS

FIG. 1 is a view of a doorbell device according to an embodiment.

FIG. 2 is an exploded view of the doorbell device illustrated in FIG. 1.

FIG. 3 is a view of a bracket and a viewing angle-adjusting bracket.

FIG. 4 is a plan view of the bracket.

FIG. 5 is a view of a bracket including a plurality of mechanism connectors.

FIG. 6 is a view of a front surface of the viewing angle-adjusting bracket.

FIG. 7 is a view of a rear surface of the viewing angle-adjusting bracket.

FIG. 8 is a view of a doorbell body.

FIG. 9 is a view of a square bracket.

FIG. 10 is a view of a front surface of a square viewing angle-adjusting bracket.

FIG. 11 is a view of a rear surface of the square viewing angle-adjusting bracket.

FIG. 12 is a view of a rectangular bracket.

FIG. 13 is a view of a front surface of a rectangular viewing angle-adjusting bracket.

FIG. 14 is a view of a rear surface of the rectangular viewing angle-adjusting bracket.

FIG. 15 is a view of a tilting angle of a camera.

FIG. 16 is a view of a camera having a changed optical axis.

FIG. 17 is a view of a doorbell device according to another embodiment of the present invention.

FIG. 18 is a view of a doorbell device according to another embodiment of the present invention.

FIG. 19 is a view of a doorbell device according to another embodiment of the present invention.

FIG. 20 is a view of a doorbell body having a slanted rear surface.

FIG. 21 is a view of a doorbell device according to another embodiment.

FIG. 22 is a view of a doorbell device according to another embodiment.

### MODES OF THE INVENTION

Objectives, specific advantages, and new features of the present invention will become more apparent from the following detailed description and exemplary embodiments involved in the attached drawings. Terminology or terms used in the present specification and the claims should not be interpreted to being limited in a general or dictionary sense but should be interpreted in a sense and a concept that comply with the technical spirit of the invention based on a principle that the inventor can properly define the concept of the term so as to describe his/her own invention in a best manner. In the description of the invention, a detailed description of a related, commonly-used technology that may unnecessarily obscure the subject matter of the invention is omitted.

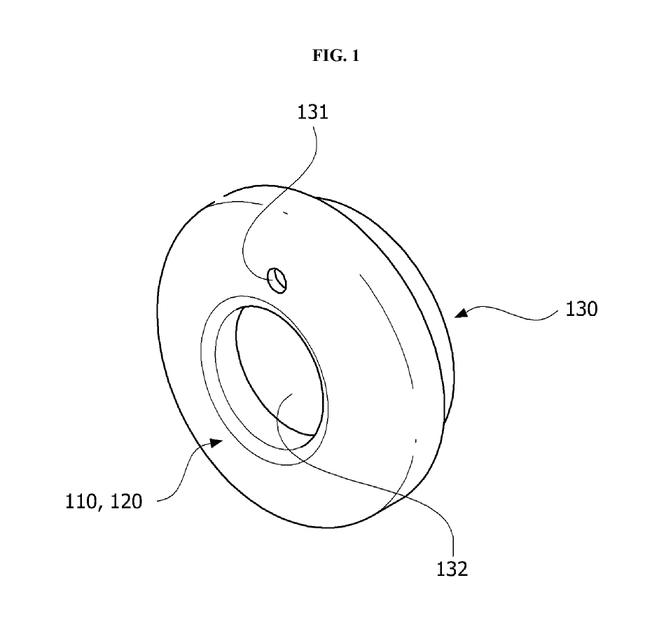

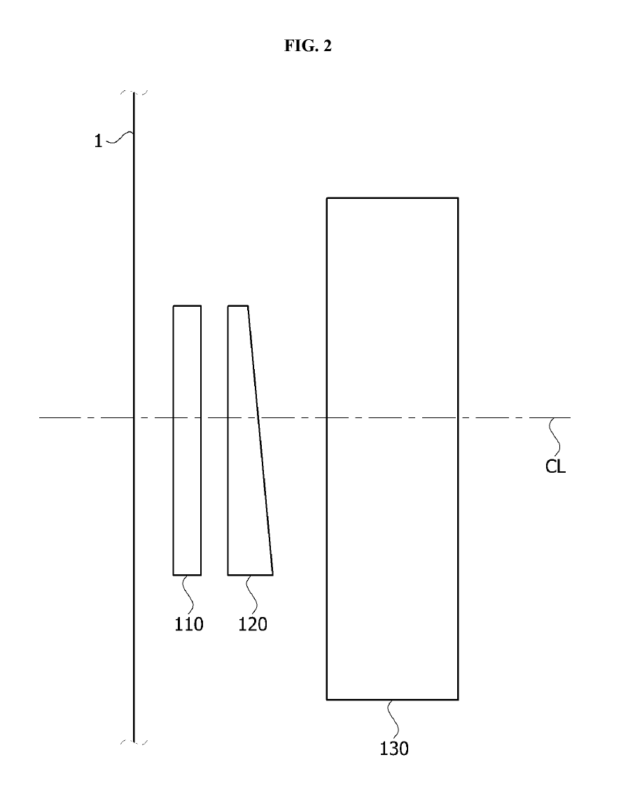

FIG. 1 is a view of a doorbell device according to an embodiment, and FIG. 2 is an exploded view of the doorbell device illustrated in FIG. 1. FIGS. 1 and 2 clearly illustrate only main portions for conceptually and clearly understanding the embodiment. As a result, various modifications of the illustrations are expected, and the scope of the invention does not need to be limited by certain shapes illustrated in the drawings.

Referring to FIGS. 1 and 2, a doorbell device according to an embodiment may include a bracket 110, a viewing angle-adjusting bracket 120, and a doorbell body 130.

The bracket 110 is coupled to a wall surface on which a door is formed, so as to fix the viewing angle-adjusting bracket 120 or the doorbell body 130 to a wall surface 1. The appearance of the bracket 110 may be embodied in various shapes, such as a circular shape, an oval shape, and a square shape, to correspond to the shape of the doorbell body 130. A fastening hole, through which the bracket 110 is coupled to the viewing angle-adjusting bracket 120 or the doorbell body 130, may be provided in the bracket 110.

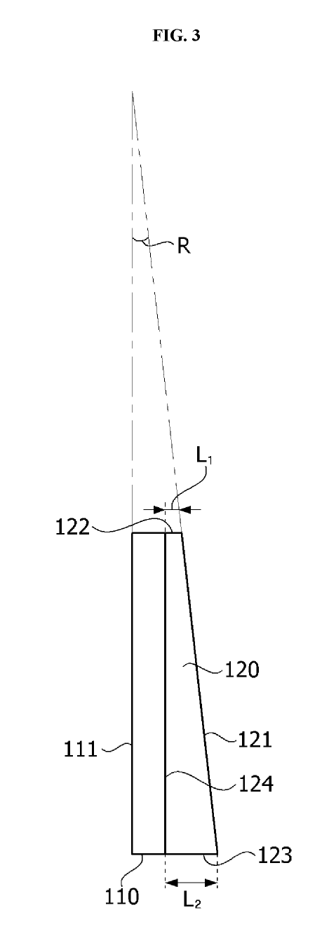

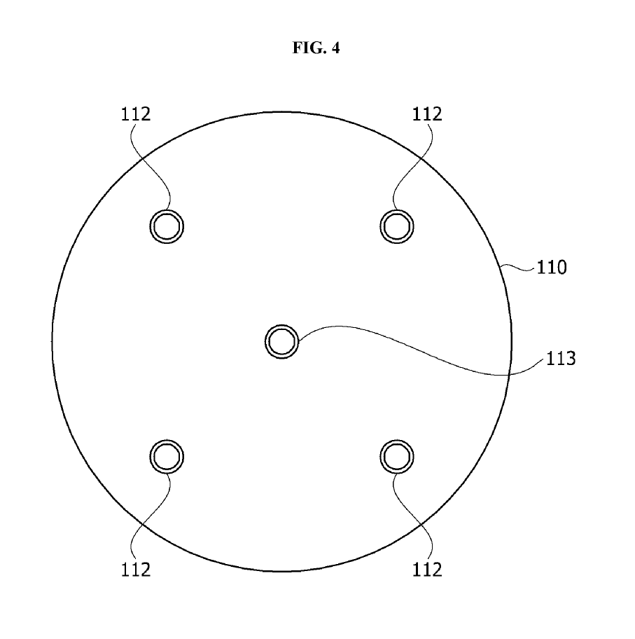

FIG. 3 is a view of a bracket and a viewing angle-adjusting bracket, and FIG. 4 is a plan view of the bracket.

Meanwhile, referring to FIGS. 2 and 3, a fixed surface 111 of the bracket 110 in contact with a wall surface (1 of FIG. 2) may be flatly formed. Referring to FIG. 4, the bracket 110 may include a wall surface connector 112 for fixing the viewing angle-adjusting bracket 120 or the doorbell body 130 onto the wall surface 1. Also, the bracket 110 may include a mechanism connector 113 for fixing the viewing angle-adjusting bracket 120 or the doorbell body 130.

Also, the mechanism connector 113 may be disposed in the center of the bracket 110 so as to fix the doorbell body 130 without limiting an angle.

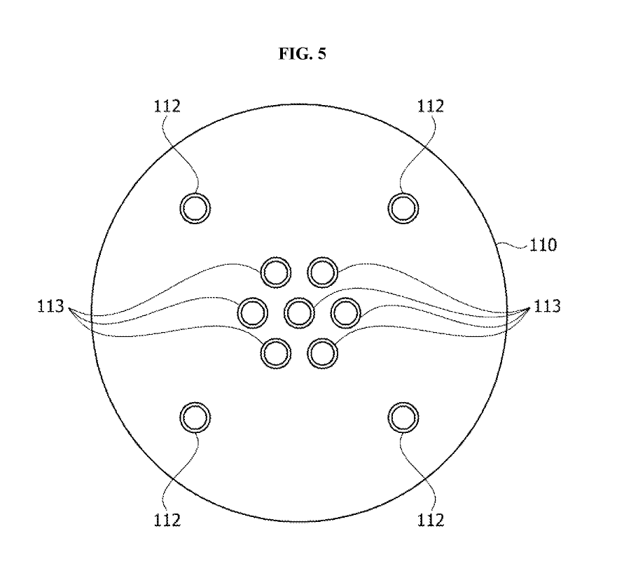

FIG. 5 is a view of a bracket including a plurality of mechanism connectors.

Referring to FIG. 5, a plurality of mechanism connectors 113 may be provided. Also, the plurality of mechanism connectors 113 may be disposed in equal intervals so as to rotate the doorbell body 130 by various angles and to fix the doorbell body 130.

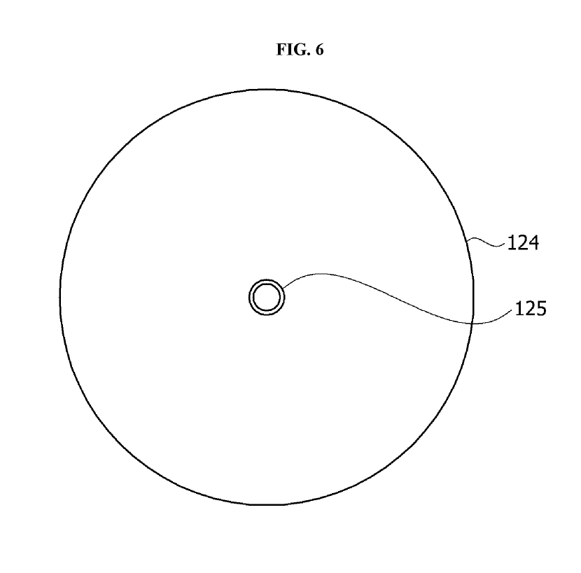

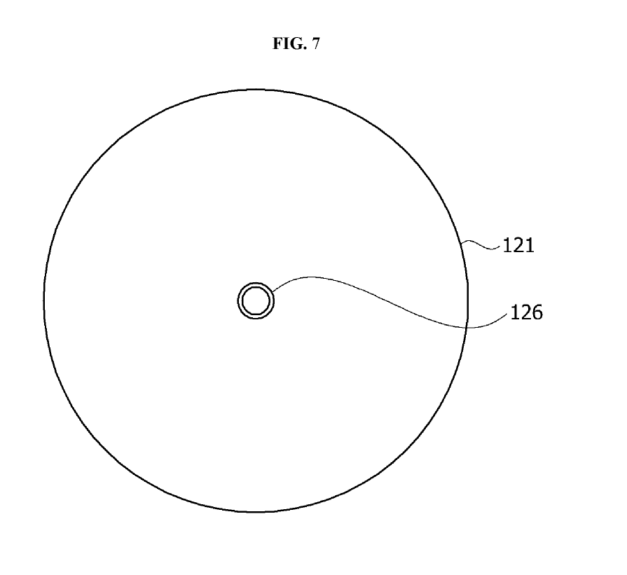

FIG. 6 is a view of a front surface of a viewing angle-adjusting bracket, and FIG. 7 is a view of a rear surface of the viewing angle-adjusting bracket.

Referring to FIG. 6, a first connector 125 may be disposed in the center of a front surface 124 of the viewing angle-adjusting bracket 120. The first connector 125 is connected to the mechanism connectors 113 of the bracket 110. Referring to FIG. 7, a second connector 126 may be provided in the center of a rear surface 121 of the viewing angle-adjusting bracket 120. The second connector 126 is connected to the doorbell body 130.

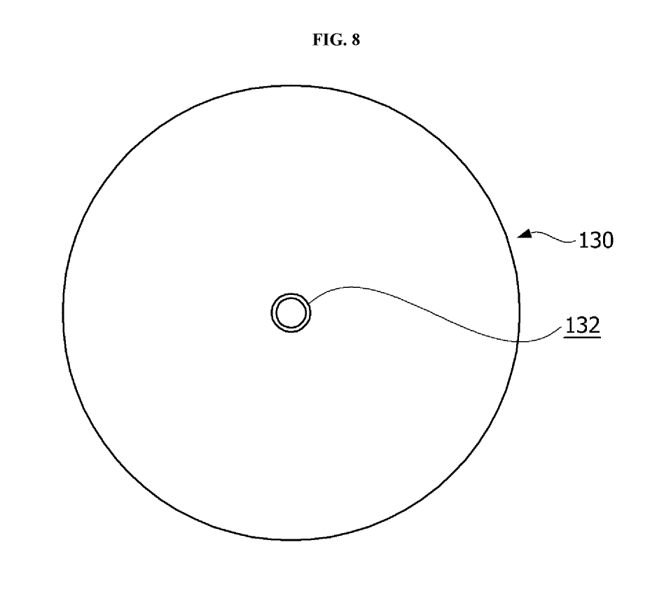

FIG. 8 is a view of a doorbell body.

Referring to FIG. 8, a third connector 132 may be formed in the center of the doorbell body 130. The third connector 132 may be connected to the second connector 126 of the viewing angle-adjusting bracket 120. Alternatively, the third connector 132 may be connected to the mechanism connectors 113 of the bracket 110.

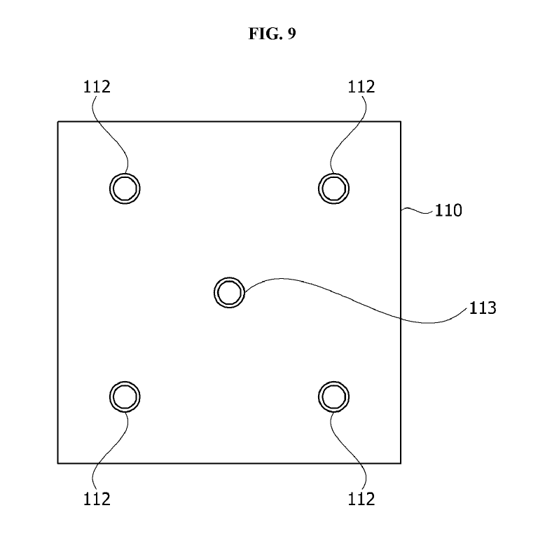

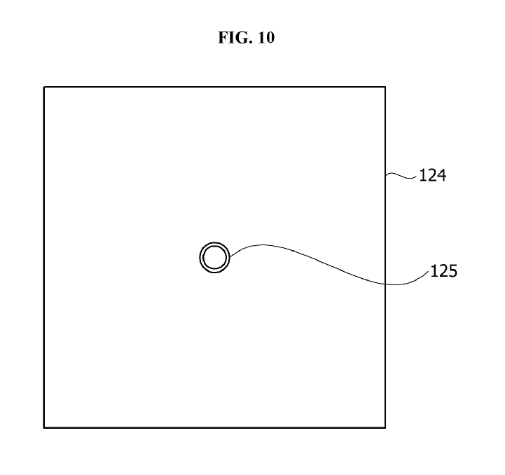

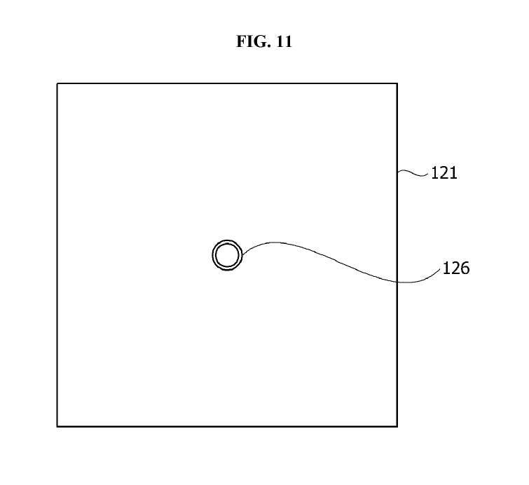

FIG. 9 is a view of a square bracket, FIG. 10 is a view of a front surface of a square viewing angle-adjusting bracket, and FIG. 11 is a view of a rear surface of the square viewing angle-adjusting bracket.

As illustrated in FIGS. 9 through 11, the viewing angle-adjusting bracket 120 and the bracket 110 may be embodied in the form of a square.

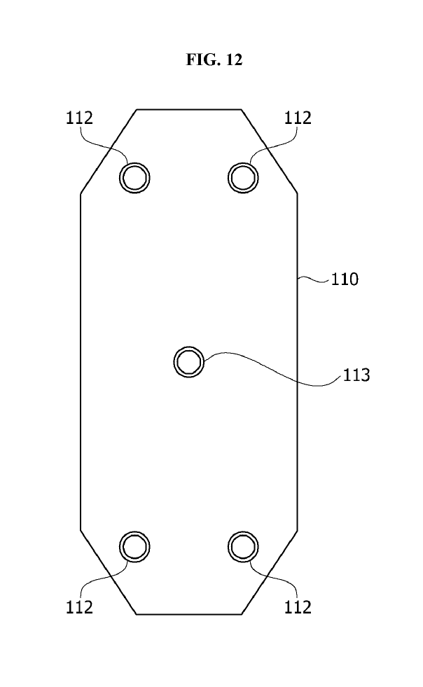

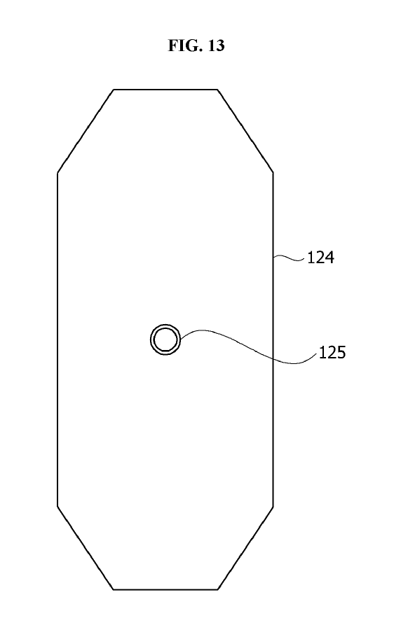

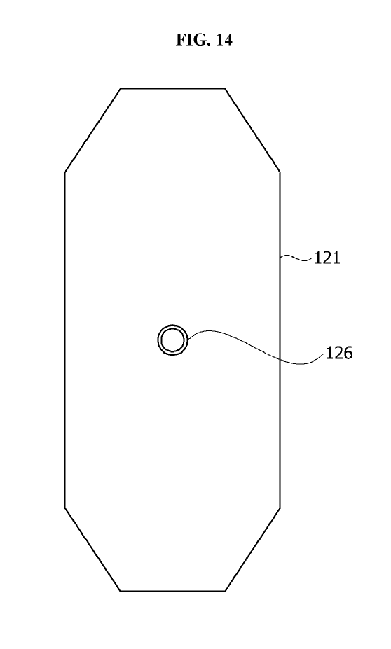

FIG. 12 is a view of a rectangular bracket, FIG. 13 is a view of a front surface of a rectangular viewing angle-adjusting bracket, and FIG. 14 is a view of a rear surface of the rectangular viewing angle-adjusting bracket.

As illustrated in FIGS. 12 through 14, the viewing angle-adjusting bracket 120 and the bracket 110 may be embodied in the form of a rectangle.

Referring to FIG. 13, the viewing angle-adjusting bracket 120 connects the bracket 110 to the doorbell body 130. The viewing angle-adjusting bracket 120 adjusts a viewing angle of a camera. A front surface 121 of the viewing angle-adjusting bracket 120 may be obliquely formed. In detail, the front surface of the viewing angle-adjusting bracket 120 opposite to a rear surface coupled to the bracket 110 may be obliquely installed to form a tilting angle R on the fixed surface 111 of the bracket 110, as illustrated in FIG. 3.

For example, when a length of a top surface 122 of the viewing angle-adjusting bracket 120 is L1 and a length of a bottom surface 123 of the viewing angle-adjusting bracket 120 is L2, L1 may be smaller than L2. The viewing angle-adjusting bracket 120 may have a trapezoidal shape overall when viewed from a lateral direction. The slanted front surface 121 is provided to acquire a tilting angle of the camera.

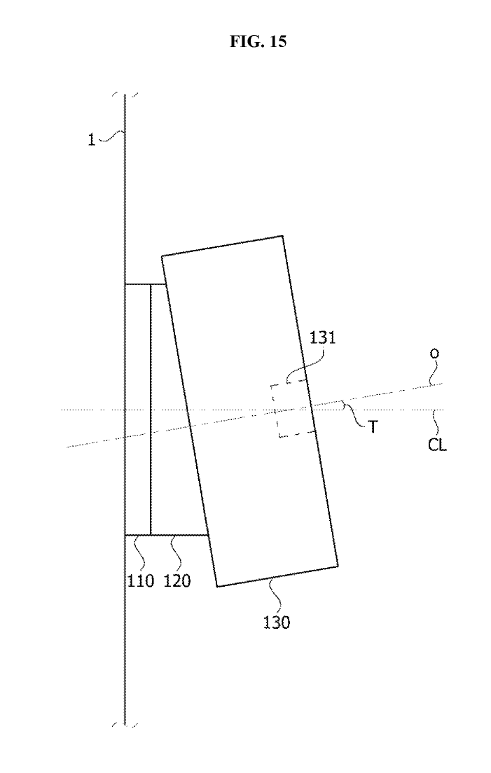

FIG. 15 is a view of a tilting angle of a camera.

Referring to FIG. 15, the viewing angle-adjusting bracket 120 may be coupled to the bracket 110 so to be rotatable about a concentric axis CL. In this case, the concentric axis CL may be formed to pass through the center of the bracket 110 and the center of the viewing angle-adjusting bracket 120.

The doorbell body 130 may be coupled to the viewing angle-adjusting bracket 120.

The doorbell body 130 may include a camera 131. The camera 131 may acquire video information on the front of a door to provide the acquired video information to a user through a separate indoor display device.

In this case, the camera 131 may be installed in the center of the doorbell body 130 so that an optical axis O of the camera 131 is inclined with respect to the concentric axis LC. In this case, an angle T between the concentric axis LC and the optical axis O may be defined as a tilting angle T of the camera 131.

Meanwhile, a bell button (132 of FIG. 1) in the form of a push button may be provided on the doorbell body 130.

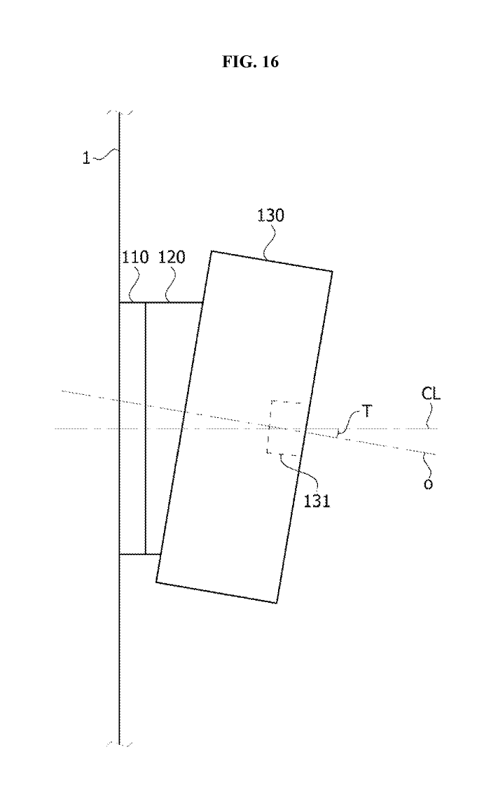

FIG. 16 is a view of a camera having a changed optical axis.

Referring to FIG. 16, when the viewing angle-adjusting bracket 120 is rotated about the concentric axis CL, the position of the optical axis O is changed due to the angle T between the concentric axis CL and the optical axis O such that the viewing angle of the camera 131 is changed. The viewing angle-adjusting bracket 120 may be configured to be rotated arbitrarily by the user using an additional manipulation unit.

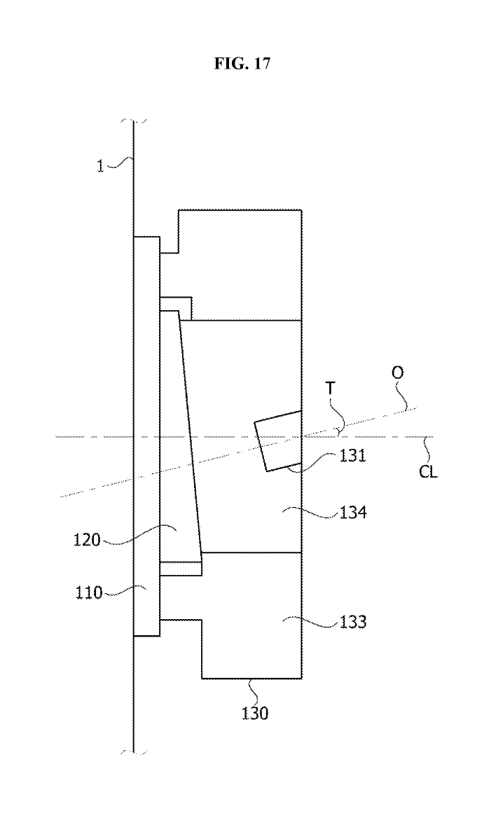

FIG. 17 is a view of a doorbell device according to another embodiment of the present invention.

Referring to FIG. 17, the doorbell device according to another embodiment includes a bracket 110, a viewing angle-adjusting bracket 120, and a doorbell body 130. The viewing angle-adjusting bracket 120 and a rotation block 134 are rotatably coupled to each other.

The doorbell body 130 may include a camera 131, a body 133, and the rotation block 134. The body 133 is coupled to the bracket 110, and the rotation block 134 is rotatably coupled to the viewing angle-adjusting bracket 120. In detail, the rotation block 134 is coupled to the body 133 and the viewing angle-adjusting bracket 120, respectively, so as to be rotatable about the concentric axis CL of the viewing angle-adjusting bracket 120.

When the rotation block 134 is rotated, the optical axis O is changed due to the angle T between the concentric axis LC and the optical axis O such that the viewing angle of the camera 131 is changed.

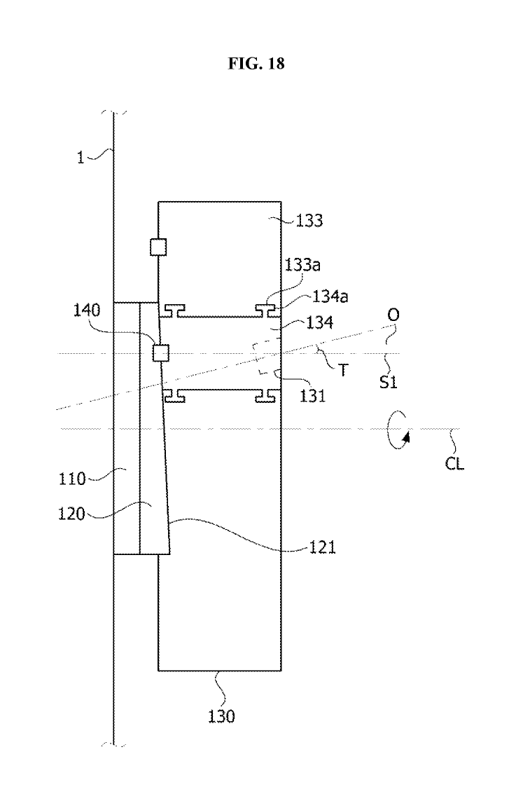

FIG. 18 is a view of a doorbell device according to another embodiment of the present invention.

Referring to FIG. 18, a rotation block 134 may be rotatably installed inside a body 133 so that an axis center S1 of the rotation block 134 is spaced apart from a concentric axis CL.

In this case, an optical axis O may be inclined with respect to the axis center S1. A rotation shaft 140 may be provided in a viewing angle-adjusting bracket 120. The rotation shaft 140 is coupled to the rotation block 134. Thus, the rotation block 134 is rotated when the rotation shaft 140 is used as an axis center, in a state in which the rotation block 134 is in contact with a slanted front surface 121 of the viewing angle-adjusting bracket 120. In this case, the rotation block 134 may have a cylindrical shape, a guide protrusion 134a may protrude from an outer circumferential surface of the rotation block 134, a cylindrical hole into which the rotation block 134 is inserted may be formed in the body 133, and a guide slot 133a into which the guide protrusion 134a is inserted may be formed on an inner circumferential surface of the cylindrical hole.

When the rotation block 134 is rotated, the position of the optical axis O is changed due to an angle T between the axis center S1 and the optical axis O such that the viewing angle of a camera 131 is changed.

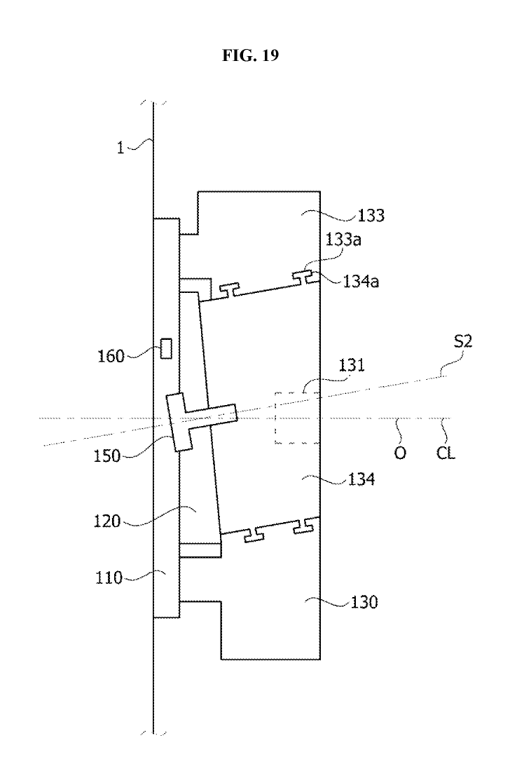

FIG. 19 is a view of a doorbell device according to another embodiment of the present invention.

Referring to FIG. 19, a rotation block 134 may be rotated by a driving unit 150. The driving unit 150 may include a motor, and an axis center S2 of the motor may be perpendicular to a front surface 121. A camera 131 may be disposed so that an optical axis O of the camera 131 is inclined with respect to the axis center S2 of the motor. In this case, the rotation block 134 may have a cylindrical shape, and a guide protrusion 134a may protrude from an outer circumferential surface of the rotation block 134. A cylindrical hole into which the rotation block 134 is inserted and may be formed in the body 133, and a guide slot 133a into which the guide protrusion 134a is inserted may be formed on an inner circumferential surface of the cylindrical hole.

A rotation angle of the driving unit 150 may be controlled by a controller 160. The controller 160 may be configured to control driving of the motor of the driving unit 150 based on a user's manipulation signal or a signal sensed through an additional sensor.

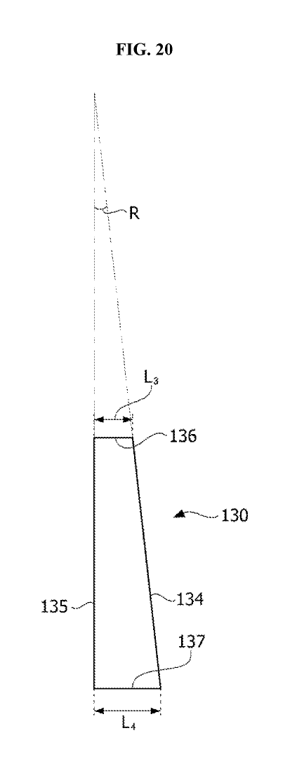

FIG. 20 is a view of a doorbell body having a slanted rear surface.

Referring to FIG. 20, a front surface 134 of a doorbell body 130 may be inclined. In detail, the front surface 134 of the doorbell body 130 may be inclined to form a tilting angle R with respect to a rear surface 135 coupled to a bracket 110.

For example, when a length of a top surface 136 of the doorbell body 130 is L3 and a length of a bottom surface 137 of the doorbell body 130 is L4, L3 may be smaller than L4. The doorbell body 130 may have a trapezoidal shape overall when viewed from a lateral direction. The inclined front surface 134 may be provided to acquire a tilting angle of a camera.

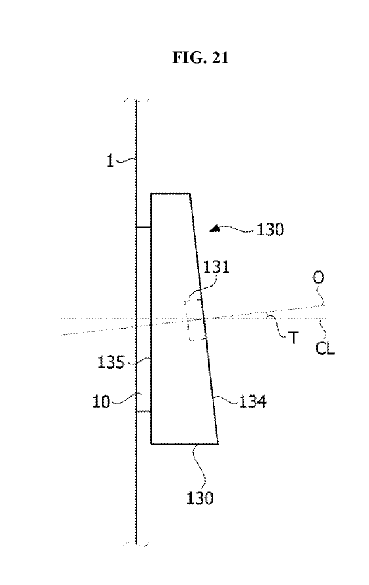

FIG. 21 is a view of a doorbell device according to another embodiment.

Referring to FIG. 21, in the doorbell device according to another embodiment, a doorbell body 130 may be directly coupled to a bracket 110 so as to be rotatable about a concentric axis CL. A front surface 130 of the doorbell body 130 is inclined so that a tilting angle T for changing the viewing angle of a camera 310 can be acquired.

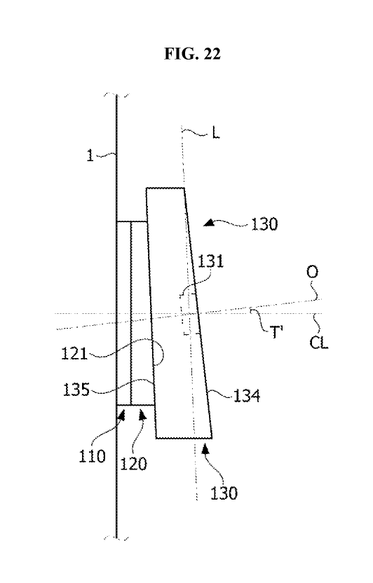

FIG. 22 is a view of a doorbell device according to another embodiment.

Referring to FIG. 22, in the doorbell device according to another embodiment, a viewing angle-adjusting bracket 120 may be coupled to a bracket 110, and a doorbell body 130 including an inclined front surface 134 may be coupled to the viewing angle-adjusting bracket 120.

Because L of FIG. 22 corresponds to an imaginary reference line L parallel to the inclined front surface 121 of the viewing angle-adjusting bracket 120, and the front surface 134 of the doorbell body 130 is inclined with respect to the reference line L, a larger tilting angle T′ than an existing tilting angle T may be acquired so that a wider viewing angle of a camera 310 can be acquired.

A doorbell device according to the embodiments above has been specifically described with reference to the attached drawings.

While the invention has been shown and described with reference to certain exemplary embodiments thereof, it will be understood by those skilled in the art that various changes in form and details may be made therein without departing from the spirit and scope of the invention as defined by the appended claims.

### EXPLANATIONS OF REFERENCE NUMERALS

110: bracket, 111: fixed surface, 120: viewing angle-adjusting bracket, 121: front surface, 130: doorbell body, 131: camera, 132: bell button, 133: body, 134: rotation block, 140: rotation shaft, 150: driving unit, 160: controller

1. A doorbell device comprising:
a bracket comprising a fixed surface coupled to a support structure;
a viewing angle-adjusting bracket rotatably coupled to the bracket and comprising a front surface inclined with respect to the fixed surface; and
a doorbell body coupled to the viewing angle-adjusting bracket and comprising a camera having an optical axis inclined with respect to an axis center of the viewing angle-adjusting bracket.

2. The doorbell device of claim 1, wherein the bracket and the viewing angle-adjusting bracket are disposed to rotate about a concentric axis.

3. The doorbell device of claim 2, wherein a length of a top surface of the viewing angle-adjusting bracket and a length of a bottom surface thereof are different from each other.

4. A doorbell device comprising:
a bracket comprising a fixed surface coupled to a support structure;
a viewing angle-adjusting bracket coupled to the bracket and comprising a front surface inclined with respect to the fixed surface; and
a doorbell body comprising a body coupled to the bracket and a rotation block, the rotation block comprising a camera which is rotatably coupled to the body and comprising an inclined contact surface in contact with the front surface.

5. The doorbell device of claim 4, wherein the camera is installed on the
rotation block so that an optical axis of the camera is inclined with respect to an axis center of the rotation block.

6. The doorbell device of claim 5, wherein the bracket comprises a driving unit connected to the rotation block and configured to rotate the rotation block.

7. The doorbell device of claim 6, wherein the driving unit comprises a motor, and an axis center of the motor is perpendicular to the front surface.

8. The doorbell device of claim 7, further comprising a controller configured to control the driving unit.

9. A doorbell device comprising:
a bracket comprising a fixed surface coupled to a support structure; and
a doorbell body rotatably coupled to the bracket, comprising one of a front surface and a rear surface inclined with respect to the fixed surface, and comprising a camera having an optical axis inclined with respect to an axis center of the bracket.
